(19) United States
(12) Patent Application Publication
(10) Pub. No.: US 2005/0132084 A1
(43) Pub. Date: Jun. 16, 2005

(54) Method and apparatus for providing server local SMBIOS table through out-of-band communication

(76) Inventors: Heung-For Cheng, Portland, OR (US); Santharaman Singaravelan, Hillsboro, OR (US)

Correspondence Address: Joni D. Stutman-Horn;BLAKELY, SOKOLOFF, TAYLOR & ZAFMAN LLP, Seventh Floor, 12400 Wilshire Boulevard, Los Angeles, CA, 90025-1030, US

(21) Appl. No.: 10/733,101

(22) Filed: Dec. 10, 2003

(51) Int. Cl. G06F 15/16

(52) U.S. Cl. 709/233

(57) ABSTRACT

A system and method is disclosed to utilize a Multiplexing Agent (MPA) and SMBIOS subagent (SBA) that run on a server to access the SMBIOS table locally. A remote out-of-band (OOB) application sends a request message to the IPMI Receive Message Queue (RMQ) buffer in the firmware. The MPA periodically retrieves from the buffer, examine, and deliver to SBA. Then SBA returns the SMBIOS information to the remote OOB SMS directly.

### FIELD OF THE INVENTION

An embodiment of the present invention relates generally to remote, out-of-band server management using server management software (SMS) and, more specifically, to utilizing an operating system multiplexing agent and SMBIOS subagent that run on a server to access the SMBIOS table locally and send SMBIOS table information to the SMS via an Intelligent Platform Management Interface (IPMI) construct.

### Background Information

During pre-boot a basic system input/output (BIOS) program loads configuration data into system management BIOS (SMBIOS) tables. The SMBIOS tables capture configuration, memory information, PCI slot information, whether the slots are enabled, whether a processor is enabled, variable information for server management, etc. Typically, the SMBIOS table records the following information: BIOS information including BIOS version; system information including universal unique identifier (UUID) of the system; baseboard information such as product information including product name and serial number; processor information; caches information such as the cache size; system slot information such as the designation of a PCI slot; memory information such as the size of the memory slot (zero, if none exist); and memory array information.

In some systems of the prior art, this information is provided through an industry standard common information model (CIM). One problem with CIM is that in order to use CIM and access data in the SMBIOS tables, a CIM object manager must run on the server. Some customers feel that the CIM object manager has a heavy weight stack and do not want the overhead of running the object manager on the server.

The System Management BIOS (SMBIOS) table is the storage in the physical memory of the local server that contains BIOS related management information such as the processor records, memory records, etc. SMBIOS is an industry standard to allow a management application to retrieve the system management BIOS information such as processor and memory information in a standard format.

Intelligent Platform Management Interface (IPMI) is an industry initiative that enables remote out-of-band (OOB) server management software (SMS) to manage the server (including temperature sensor, voltage sensor, fan sensor, power control, etc.). Remote OOB SMS manages a server by communicating with the IPMI firmware directly using connections such as LAN, Modem, and Serial.

However, IPMI doesn't provide interfaces to access the SMBIOS table directly. This table is crucial for OOB management such as determining the physical memory size. Thus, there is a need to be able to access SMBIOS information using OOB methods.

### BRIEF DESCRIPTION OF THE DRAWINGS

The features and advantages of the present invention will become apparent from the following detailed description of the present invention in which:

FIG. 1 is a block diagram of an exemplary managed network system, for example, a server having a baseboard management controller (BMC);

FIG. 2 is an exemplary managed server system according to an embodiment of the invention;

FIG. 3 is a detailed block diagram of a multiplexing agent in communication with a SMBIOS subagent, according to an embodiment of the invention; and

FIG. 4 is a flow diagram showing an exemplary method for servicing SMBIOS requests using IPMI constructs, according to an embodiment of the invention.

### DETAILED DESCRIPTION

An embodiment of the present invention is a system and method relating to remote, out-of-band server management using server management software (SMS). In at least one embodiment, the present invention utilizes an operating system multiplexing agent and system management basic input/output system (SMBIOS) subagent that run on a server to access the SMBIOS table locally and send SMBIOS table information to the SMS via an Intelligent Platform Management Interface (IPMI) construct.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

In one embodiment, the network server to be managed is compatible with the Intelligent Platform Management Interface (IPMI). The IPMI is a communication protocol for LANs or modem communication to a baseboard management controller (BMC). The IPMI 1.5 specification, jointly developed by Intel Corporation, Hewlett-Packard Company, NEC Corporation and Dell Computer Corporation, for instance, defines a mechanism by which an Out-Of-Band connection can pass data back and forth to an operating system (OS) agent via the BMC. Information regarding the IPMI 1.5 specification can be found on the Internet, specifically on the web site of Intel Corporation at http://developer.intel.com/design/servers/ipmi. In existing systems, Server Management Software (SMS) uses the IPMI mechanism to determine the OS version of the server as well as perform a shutdown of the OS remotely. These actions are performed through the use of an OS resident agent, such as Intel® Server Management, called Platform Instrumentation (PI).

The BMC is separate from the OS. PI is an OS resident agent. PI can get OS based information to which the BMC does not have access. However, the BMC can communicate with the PI. The OS resident agent obtains information that was placed, or stored, by the BMC. OS resident agents, as used in state of the art systems, only understand three commands: (i) turn off; (ii) restart, and (iii) request OS version. In current systems, the PI must exist for these actions to be performed. In some systems PI has a modular interface design, allowing it to use a plugin interface.

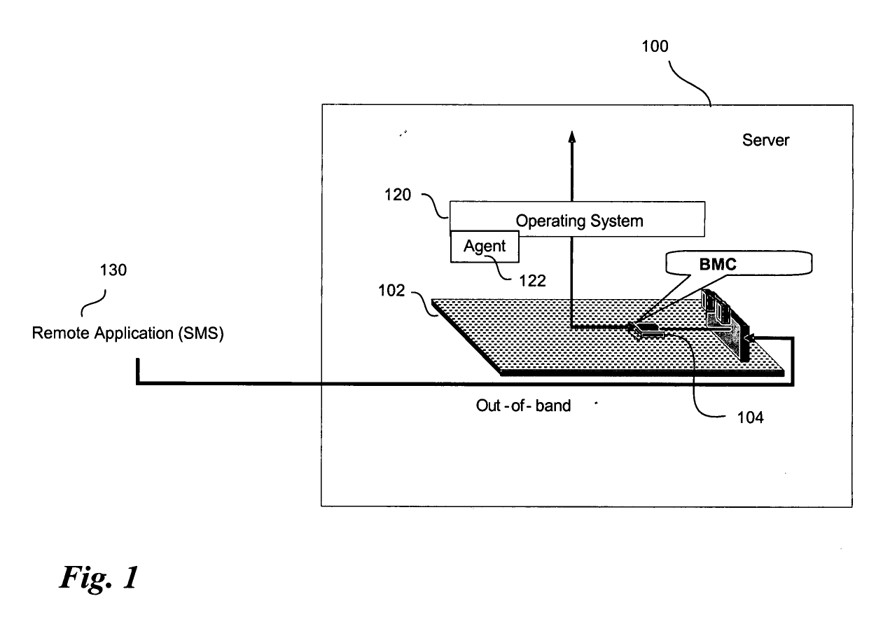

FIG. 1 is a block diagram of an exemplary managed network system, for example, a server 100. The server 100 has a motherboard 102. Operatively coupled to the motherboard 102 is a baseboard management controller (BMC) 104. In one embodiment, a remote operator uses a remote application (SMS) 130 to shutdown a server using Out-Of-Band management. The SMS 130 communicates to the BMC 104 via a modem, serial or other connector 106.

In one embodiment, there are two modes of server management: In-band and Out-Of-Band (OOB). For In-band management, the server 100 is typically running. An agent 122 runs on the OS 120 with standard level sockets, for instance, TCP/IP, UDP (User Datagram Protocol, a network protocol for transferring data packets), CIM (common information model) or DMI (desktop management interface). Out-Of-Band management is independent of the OS and OS state. In one embodiment, the OS is typically running to perform the requested actions, because the Agent 122 and BMC 104 communicate with each other.

Embodiments of the present system and method provide a lightweight process that gets the SMBIOS information without going through a common information model (CIM) requiring an object manager. Embodiments of the present system and method facilitate server management. Currently, the CIM standard requires an object manger which allows the clients to always connect to the object manager. The provider must provide a schema. The schema must be loaded into the object manager. The schema specifies the data provided by the provider to the object manager. When a client system asks for that data, the provider defines which object provides that data. The object manager is located on the server and requires server resources. To request the data from the client system, existing systems require an object manager on the server system. Thus, for example, the Microsoft® Windows™ family of operating systems runs a schema object manager, while in the Linux operating system family, an object manager is not typically part of the operating system and needs to be installed. The provider has the SMBIOS information.

In embodiments of the present system and method, an object manager is not required, thereby saving server resources. The existing IPMI firmware interface is extended to provide the information, instead. The data transfers are performed during runtime using lightweight operating system agents. The CIM object manager and schema is not required. In some embodiments, not as many resources are saved in a Windows™ environment because the object manager must run anyway. However, if the data/action request does not need to go through Windows™, then some overhead is saved because the interface overhead is eliminated when communication goes through IPMI.

In existing systems, IPMI is used as a firmware interface and basically provides information about different sensors. A server system may have a voltage sensor, temperature sensor, fan sensor and other sensors. Utilizing the IPMI mechanism, the server manager can determine the sensor data, e.g., temperature of a hardware component and the threshold for that reading. For instance, if the fan reading is significantly below the threshold, then the fan is operating very slowly. If so, then the fan may not dissipate enough heat at this speed. The IPMI may generate a message based on the sensor reading with respect to the threshold. The IPMI interface allows the server manager to manage the platform data inside the board.

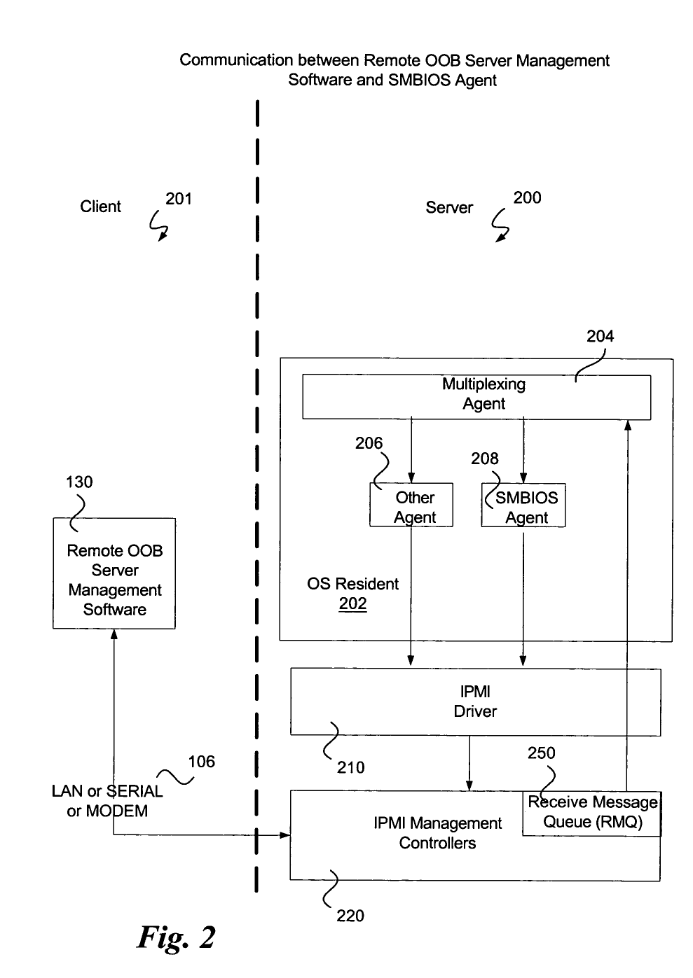

Referring now to FIG. 2, there is shown an exemplary managed server system according to an embodiment of the invention. A small buffer defined by IPMI, the received message queue (RMQ) 250, allows communication between a client system 201 and the host 200 operating system 202. An IPMI driver 210 communicates with the IPMI management controllers 220. The RMQ 250 is closely integrated with the IPMI management controllers 220 which communicate with the server management software 130 residing on the client management system 201 via a LAN, serial or modem connection 106.

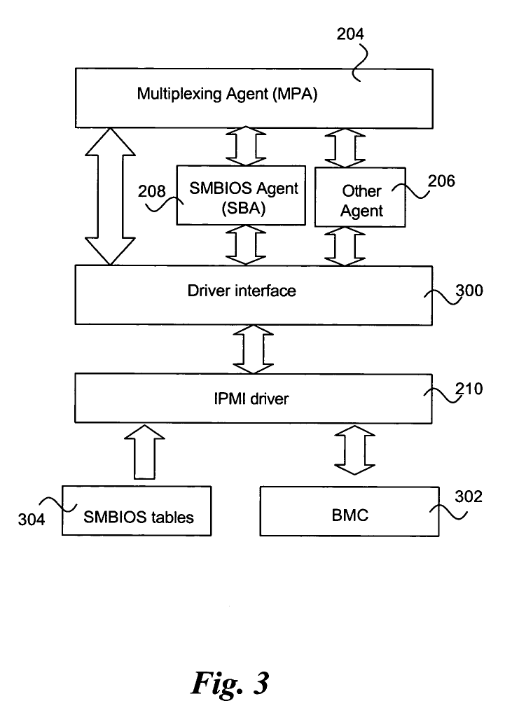

FIG. 3 shows a more detailed block diagram of a system according to an embodiment of the invention. Referring to FIGS. 2 and 3, in an embodiment, an out-of-band (OOB) Server Management Software (SMS) 130 in the client system 201 manages the servers with Intelligent Platform Management Interface (IPMI) 300 capability and SMBIOS table information 304. In this embodiment, the servers 200 contain the IPMI management controllers 220 such as Baseboard Management Controller (BMC) 302 allowing remote management applications to manage the server through OOB connection such as LAN, SERIAL, and MODEM 106. There is a Receive Message Queue (RMQ) 250 in BMC to allow communication between OOB SMS with any server resident software such as the Multiplexing Agent (MPA) 204 as described herein. The server 200 also has an IPMI Driver 210 running. The MPA 204 running in the server accepts all incoming OOB requests placed in the RMQ. If the request is not understood, it is typically ignored. If the request is for SMBIOS information, the MPA delivers the request to the SMBIOS subagent (SBA) 208. SBA is also located in the server. During initialization, the SBA 208 reads the local SMBIOS table 304 on the server. Then the SBA 208 starts to service requests from OOB SMS 130 on SMBIOS records.

The client 201 deposits a request in the RMQ 250 using OOB communications. The multiplexing agent 204 running on the server monitors the RMQ 250. When a message is received, it is decoded and acted upon by the agent 204. In the case of SMBIOS requests, the multiplexing agent 204 invokes the SMBIOS agent 208 which services the request. Generally, the MPA 204 services requests itself or invokes other agents 206, 208 to service the request. Requests which are not understood, or which do not have an active agent are ignored. If data is requested, the server sends the data to the client application utilizing the appropriate agent for the request and using the IPMI Send Message command. Part of the information placed in the RMQ 250 is header information identifying the requesting client 201. When the server agent sends back the data it includes identifying information defining the client.

The Multiplexing Agent's functionalities may include 1) loading the individual subagents such as SBA; performing the registration of these subagents; accepting the OOB requests from the RMQ; and dispatching the valid requests to the corresponding subagents for servicing. When the server's OS boots up, MPA may be started automatically. During its initialization, the server may flush the RMQ to clear all the old requests. Then the server may load all subagents as a dynamic link library. Each subagent registers itself with the MPA using a predefined interface to provide a callback function, and the requests that it can service by the callback. If there are multiple callback functions to service different requests, the subagent may perform multiple registrations.

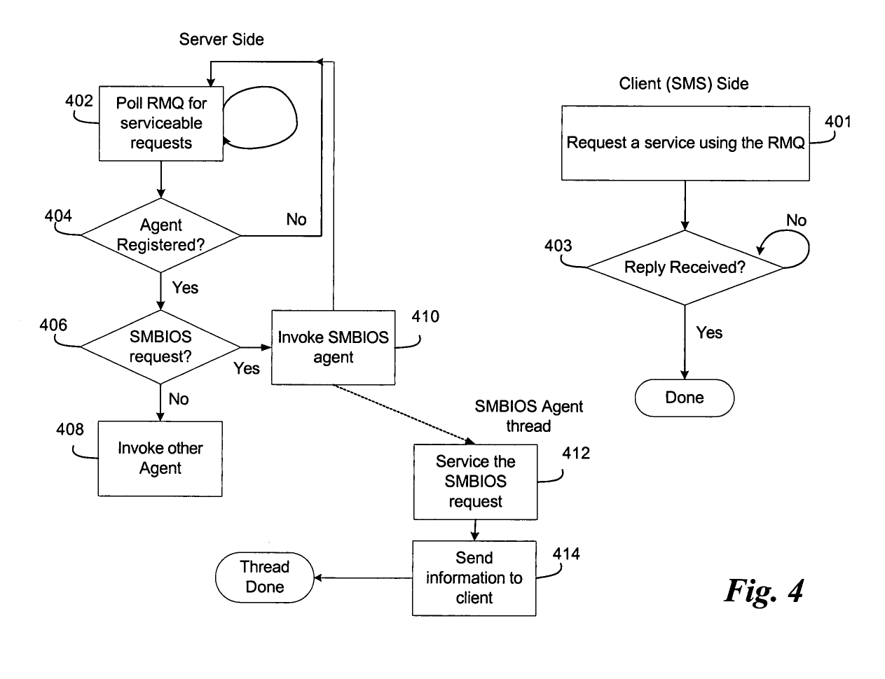

Referring now to FIG. 4, there is shown an exemplary method for servicing SMBIOS requests using IPMI constructs. In this embodiment, a client side SMS requests information by placing a request in the RMQ in block 401. The SMS waits for a reply in block 403. In some embodiments, the SMS performs other functions in parallel or using multiple threads while it waits for a reply.

The MPA may start to accept the OOB requests by polling/reading the RMQ in block 402. If no requests are found, the MPA continues to poll the RMQ at 402. If a request is one of the valid requests registered by the subagent, as determined in block 404, the MPA find the corresponding subagent(s) callback function and invoke it to service the request, in block 408. If there are multiple callback functions for the single request, each callback function may be invoked. If, for example, the incoming request is to get a SMBIOS processor record, as determined in block 406, and the SMBIOS subagent (SBA) has registered for the “SMBIOS Get Record” request with a callback function, MPA may invoke the callback function with the SMBIOS processor record type and the record number in block 410. The callback function services the request in block 412 by retrieving the corresponding record. The callback function may then respond with the record data to the originator of the request through the IPMI Send Message command in block 414. While the SMBIOS agent is servicing the request, the MPA is free to continue to poll the RMQ for additional requests (block 402) and invoke other agents (block 408).

In some embodiments, on the client side, before a new request is issued to the managed server, the OOB SMS may check if the request is on its valid request list. If not, it may make an OOB request “Enumerate All Valid Requests” to the managed server. On the managed server side, the MPA may check if there is any new subagent needed to be loaded from the predefined directory. If so, it loads the subagent which, in turn, registers with any new valid requests. The MPA registration table is then updated, and then the MPA responds with the list of valid requests to the OOB SMS application in the client. This mechanism allows new subagents to be dynamically added into the framework.

The SMBIOS Agent (SBA) is one of the subagents and provides SMBIOS information such as Processor, Memory, PCI slots, etc. This subagent may be implemented as a dynamic link library and then loaded by the MPA. In some embodiments, when the SBA is loaded, it maps the SMBIOS tables 304 located in the physical memory to virtual memory and access the SMBIOS table. Using the virtual memory pointer the SBA may search for the SMBIOS signature. The SBA may obtain a physical address of the actual SMBIOS tables. For 32-bit architecture systems, a 32-bit address, typically starts at the 18th byte from the location where the SMBIOS signature was detected. The address is typically the size of a DWORD (double word), so for 64-bit architecture, it may be a 64-bit address. It will be apparent to one of ordinary skill in the art that the address size may be dependent on system architecture. The address may be used to locate the actual SMBIOS records in the physical memory that may be used to serve any requests for SMBIOS information via the MPA.

In existing systems, when information is sent to the RMQ, the receiving agent is one overarching piece of software that must service all known requests. The disclosed system and method uses a watchdog agent (multiplexing agent, MPA) which passes the request along to a plurality of subagents. The several subagents are already running. The MPA runs as a background service. The MPA loads and registers the subagents. In one embodiment, the subagents are implemented as dynamic link libraries (dll). These may be loaded while the agent is running. Thus, the system can be dynamically extended with additional subagents. Agents in the prior art cannot be extended because there is one module that handles all of the requests. No plug-ins are allowed.

Extending the disclosed system and method allows independent hardware vendors (IHVs) to create their own subagents that basically plug in to the multiplexing agent. One can control a new RAID card, for instance, by using requests that are understood by the new subagent. The multiplexing agent knows what subagents are in its control. It knows which types of requests are to be serviced by which subagent.

In one embodiment, while the server is running, an operator/system administrator adds a subagent, then a client application asks for a new request. The multiplexing agent receives the request, but does not know which subagent to use. None has been registered. In an embodiment, the multiplexing agent looks in a specified directory for new subagents and dynamically registers them. Now that the subagent is registered, the multiplexing agent knows which subagent to launch to service the request.

The MPA is aware of the registered subagent and the callback function for the subagent. The MPA passes all of the data from the RMQ to the subagent callback function. The callback function of the subagent then takes control of the service.

The MPA may have multiple threads. It may spawn additional threads for multiple callback functions. Since the MPA is multi-threaded, it can continue to poll at the same time the subagents are servicing the requests.

The techniques described herein are not limited to any particular hardware or software configuration; they may find applicability in any computing, consumer electronics, or processing environment. The techniques may be implemented in hardware, software, or a combination of the two. The techniques may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, that may include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by the machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1. A method for remotely managing a computing device, comprising:
receiving, by the computing device, a service request sent by a remote application via an out-of-band (OOB) connection;
storing the service request in a selected storage location;
polling the selected storage location by a multiplexing agent for new requests;
determining a subagent corresponding to the received service request;
invoking the corresponding subagent, wherein the corresponding subagent services the service request; and
sending a response to the remote application to indicate that the service request has been performed.

2. The method as recited in claim 1, wherein the determined subagent is a system management basic input output system (SMBIOS) agent, and wherein the SMBIOS agent accesses the SMBIOS tables to fulfill the service request.

3. The method as recited in claim 1, wherein the selected storage location is a receive message queue (RMQ) construct of intelligent platform management interface (IPMI).

4. The method as recited in claim 3, wherein the service request comprises header information identifying a client sending the service request.

5. The method as recited in claim 4, wherein the response is sent to the identified client using a send message construct of IPMI.

6. The method as recited in claim 1, wherein the subagent registers a callback function with the multiplexing agent, wherein the callback function corresponds to a service request type.

7. The method as recited in claim 6, wherein a subagent has a plurality of corresponding callback functions.

8. The method as recited in claim 1, wherein the multiplexing agent continues to poll the selected storage location simultaneously with the servicing of a service request by the subagent.

9. The method as recited in claim 1, further comprising accepting dynamic updates of available subagents by the multiplexing agent.

10. The method as recited in claim 9, wherein accepting dynamic updates of available subagents comprises:
identifying an added dynamic link library in a predetermined storage location, the added dynamic link library corresponding to a new subagent; and
registering at least one callback function corresponding to the added dynamic link library with the multiplexing agent, wherein the identifying and registering are performed during runtime.

11. A machine accessible medium comprising instructions for servicing out-of-band service requests, the instructions structured to cause a machine to:
receive, by the computing device, a service request sent by a remote application via an out-of-band (OOB) connection;
store the service request in s selected storage location;
poll the selected storage location by a multiplexing agent for new requests;
determine a subagent corresponding to the received service request;
invoke the corresponding subagent, wherein the corresponding subagent services the service request; and
send a response to the remote application to indicate that the service request has been performed.

12. The machine accessible medium as recited in claim 11, wherein the determined subagent is a system management basic input output system (SMBIOS) agent, and wherein the SMBIOS agent accesses the SMBIOS tables to fulfill the service request.

13. The machine accessible medium as recited in claim 11, wherein the selected storage location is a receive message queue (RMQ) construct of intelligent platform management interface (IPMI).

14. The machine accessible medium as recited in claim 13, wherein the service request comprises header information identifying a client sending the service request.

15. The machine accessible medium as recited in claim 14, wherein the response is sent to the identified client using a send message construct of IPMI.

16. The machine accessible medium as recited in claim 11, wherein the instructions are structured to register a callback function with the multiplexing agent, by the subagent, wherein the callback function corresponds to a service request type.

17. The machine accessible medium as recited in claim 16, wherein a subagent has a plurality of corresponding callback functions.

18. The machine accessible medium as recited in claim 11, wherein the multiplexing agent continues to poll the selected storage location simultaneously with the servicing of a service request by the subagent.

19. The machine accessible medium as recited in claim 11, further comprising instructions structured to accept dynamic updates of available subagents by the multiplexing agent.

20. The machine accessible medium as recited in claim 19, wherein instructions structured to accept dynamic updates of available subagents comprise:
identifying an added dynamic link library in a predetermined storage location, the added dynamic link library corresponding to a new subagent; and
registering at least one callback function corresponding to the added dynamic link library with the multiplexing agent, wherein the identifying and registering are performed during runtime.

21. A system for servicing out-of-band (OOB) service requests, comprising:
a processor communicatively coupled to a memory store and a baseboard management controller (BMC), wherein the BMC is configured to accept service requests from a remote application communicating with the BMC via an OOB connection, wherein accepted service requests are stored in a selected storage location in the memory store;
a multiplexing agent running on the processor, the multiplexing agent polling the selected storage location for a new service request; and
at least one subagent running on the processor, wherein a subagent corresponding to a service request type is invoked by the multiplexing agent in response to receiving a new service request.

22. The system as recited in claim 21, wherein one of the at least one subagent is a system management basic input output system (SMBIOS) subagent, wherein the SMBIOS subagent services requests requiring access to SMBIOS tables.

23. The system as recited in claim 21, wherein the selected storage location is a receive message queue (RMQ) construct of intelligent platform management interface (IPMI).

24. The system as recited in claim 23, wherein the service request comprises header information identifying a client sending the service request.

25. The system as recited in claim 24, wherein a response is sent to the identified client using a send message construct of IPMI to indicate service request completion.

26. The system as recited in claim 21, wherein the at least one subagent registers a callback function with the multiplexing agent, wherein the callback function corresponds to a service request type.

27. The system as recited in claim 26, wherein a subagent has a plurality of corresponding callback functions.
